(19) United States
(12) Patent Application Publication
(10) Pub. No.: US 2009/0301956 A1
(43) Pub. Date: Dec. 10, 2009

(54) Modular debris rack

(76) Inventor: Richard Coppola, Langhorne, PA (US)

Correspondence Address: Richard Coppola, 25 Parkside Dr., Langhorne, PA, 19047, US

(21) Appl. No.: 12/455,217

(22) Filed: May 30, 2009

Related U.S. Application Data
(60) Provisional application No. 61/129,190, filed on Jun. 10, 2008.

(51) Int. Cl. B01D 35/31

(52) U.S. Cl. 210/232

(57) ABSTRACT

A modular debris rack device for preventing foreign or other materials from entering into fluid, water intake, inlet, or outlet equipment and facilities, flow control systems, hydraulic structures, waterways and marine structures and facilities and/or intermediately retaining foreign or other materials at or within such structures and waterways being comprised of one or plurality of linear or curved upper, lower, opposing, radial, conical, and/or side to side rack frames, and/or optionally installed intermediate rack frames with solid or tubular round, square, rectangle, angled, or other shape removable rigid rack bars, and/or removable flexible rack cables, cords, chain, rope, or other type flexible longitudinal structures that may be collectively referred hereinafter as “rods”, or “rack retention elements” to fit the desired rack orientation and spacing installation requirements. The modular debris rack permits installation and removal the modular debris rack, rack frames, and removal and reinstallation of rack frame bar components without tools, and simple removal or replacement of individual rack frame components either without tools or with a minimal amount of tools. The modular debris rack frame can be made from any materials such as steel, aluminum, fiberglass, plastics, rubber, or any combination thereof, and other elements to any required size or shape installed either individually or by grouping and can be installed at any angle or orientation.

### FIELD OF THE INVENTION

The present invention relates to a modular debris rack installed in the marine and/or underwater and other environment for preventing foreign or other materials from entering into fluid, water intake, inlet, or outlet equipment and facilities, flow control systems, hydraulic structures, waterways and marine structures and facilities either not submerged, partially submerged, and/or completely submerged.

More specifically, it relates to a means for preventing foreign or other materials from entering into fluid, water intake, inlet, or outlet equipment and facilities, flow control systems, hydraulic structures, waterways, marine, and other structures and facilities and/or retaining foreign or other materials at or within such structures and waterways being comprised of one or plurality of linear or curved upper, lower and/or side to side rack frames, and/or optionally installed intermediate rack frames with solid or tubular round, square, rectangle, angled, or other shape removable rigid rack bars, and/or removable flexible rack cables, cords, chain, rope, or other type flexible longitudinal structures to fit the desired rack orientation and spacing installation requirements. The modular debris rack permits rapid removal and reinstallation of the modular rack, and rack bar components without tools or with minimal tools and simple removal or replacement of individual rack frame components without tools, and permits rapid access to flow control devices and other equipment and facilities located behind the modular debris rack for inspection, maintenance, repair and replacement. The modular debris rack frame can be any size and shape, and be single or multi-sided, made from any semi-rigid and/or rigid materials such as steel, aluminum, fiberglass, plastics, and other elements to any required size or shape installed either individually, grouping, stacking, or layering and can be installed at any angle or orientation.

### BACKGROUND OF INVENTION

Debris racks, trash racks, and other such equipment in the marine and other environments are prevented from rapid removal and reinstallation in whole and in part due to being constructed as a unit, and being fixed as a unit to equipment, structures, and other facilities installed by welding, embedment, riveting, bolting, and other respective permanent and semi-perminant joining and connection methods thereby preventing the removal and reinstallation of the unit, its parts, or individual elements of the constructed unit and substantially preventing and limiting efficient removal and replacement of the unit in whole and/or in part. For these reasons, there is a need in the art for a new system to permit a modularly constructed debris rack device for modular, rapid disassembly, removal, and reinstallation of its components which overcomes the above disadvantages described.

### BRIEF DESCRIPTION OF THE DRAWINGS

FIG. 1 is an elevation view showing the position in this sample installation of the two rack frame component ends (3E1) and (3E2) in this case with upper and lower orientation in front in of a sluice type flow control gate (1), installed in this example to a concrete control tower (2) by a selected quantity of mounting studs (3E1H) and (3E2H) in selected drilled holes in frame components.

FIG. 2 is a plan view showing a sample installation of the modular rack frame (3E1-E2) to a curved structure (2) using mounting studs (4W) with a sluice gate type flow control device installed (1) to the structure. Other installations of this type example can be made on an irregular shaped, elliptical, curved, flat, offset, round, or other shape structures. Also shown is one of the variants to welded frame component construction using two end plates and bolted or fitted variable size brackets (3A), (3B), (3AB) with removable drilled frame end plates (5), (5FH). Also shown are drilled frame rod holes (3-4FH) for installation in this example of round frame rods. a plurality of other shaped rods or elongated structures functioning in similar capacity are also used.

FIG. 3 is an elevation longitudinal view of a sample weld assembled frame construction matrix showing the primary parts of a combined single element rack frame component (4) which in this variant of the various construction and configuration types without limitation of the modular debris rack is composed of three elements being the top plate (2A), back plate (2B), and bottom plate (2C). The center illustration shows the three elements combined as a vertically oriented upper end rack frame component with drilled rod holes (2FH) and (2E1H) through the top plate (2A), bottom plate (2B), and backing plates. Also shown is an optional hardware connected top plate cap (2D). The bottom illustration shows the three elements combined as a vertically oriented lower end rack frame component with drilled rod holes (2FH) in the top plate and backing plate (2E2H).

FIG. 4 is an elevation front view of a hardware assembled rack frame showing the primary parts of a rack frame which in this variant of the various construction and configuration types without limitation of the modular debris rack is composed of three elements being the top plate (2E), mounting brackets (2AB), and bottom plate (2F). Also shown is an optionally installed hardware connected plate cap used for rod retention (2G). The bottom illustration go shows the three elements combined as a vertically oriented upper end rack frame component with the mounting bracket positioned as installed with connecting plate hardware (4A), and frame mounting hardware (4W).

FIG. 5 is an elevation front view of curved upper and lower rack frame components (3E1), and (3E2) with rack frame bars (6), rack frame mounting studs (4), and optionally installed hardware connected end plates (5) drilled for connecting hardware (5H-FH). Also shown are optionally installed side plates shown face view (7S1), and side view (7S2). Side plates may be pre-drilled (7H) or slotted (7S) in a pattern for infield adjustment for desired rack frame separation.

FIG. 6 is a combination elevation front view of an assembled rack frame component (3E1-E2), with drilled back plate mounting holes (2E1H/2E2H) and plan view of a rack frame component (3E1-E2) with temporary and optionally installed centering arms and connecting hardware accessories (3E1-E2-OCH). Also shown is an optionally installed plate cap (2D) for rod retention.

FIG. 7 is a combination elevation front view of a straight rack frame component (3E1-E2-S) with orientation of optionally installed rack frame sliding plate cap (2D) and a plan view of an optionally installed rack frame (3E1-E2-T) with tabbed sliding plate cap (2D), and plan views of optional rack frame end caps secured by a continuous length channel and partial length tabs.

FIG. 8 is a combination an elevation front and plan views of a straight rack frame component (3E1-E2) at bottom with pre-drilled mounting stud holes (3-4H), and rack frame rod holes (3-4FH), and a plan view at top of a curved rack frame component (3E1-E2), with pre-drilled rack frame rod holes (3-4H), and rack frame mounting studs (4W), with optionally installed rack frame spacer (4OS) typically installed behind the rack frame back plate (2B) and between the rack frame and the structure.

FIG. 9 is an elevation view of a rack assembly variant oriented vertically with upper and lower rack frames (3E1) and (3E2), rack bars positions as being installed from the top (6P), and installation with rods fully seated (6). Also shown are various rod shapes without limitation to shape, dimension, or size which may be used between and within the rack frames (6V). Also shown is an optionally installed hardware secured top end plate cap (2D), and rack frame side plates (7S1) and (7S2) with connecting hardware at each end (5H-4A-4P).

FIG. 10 is a group of four side section views of a hardware assembled upper rack frame plate mounting bracket (2AB) secured to a structure (2), with mounting studs (4W), with a rack bar plate cap (2D) positioned to be secured to the top plate (2E) by connecting hardware (4A). Also shown is the bottom plate (2F) attached to the frame mounting bracket (2AB). The second illustration down from the top is a side view showing a weld assembled upper end rack frame component (4) secured to a structure (2), with mounting studs (4W), with a rack bar plate cap (2D) positioned to be secured to the top plate. Also shown is a section view of a rod (6) installed within the rack frame (4). The third illustration down from the top is a side view showing a weld assembled upper end rack frame component (4) secured to a structure (2), with mounting studs (4W), with a rack bar plate cap (2D) installed on the top plate with connecting hardware (4A). The bottom illustration is a side view showing a weld assembled slotted/tab upper end rack frame component (3E1-E2-S)/(3E1-E2-T) secured to a structure (2), with mounting studs (4W), with a rack bar plate cap (2D) positioned to be secured to the top plate. Also shown is a section view of a rod (6) installed within the rack frame (4).

FIG. 11 is a group of three side section views of four lower rack frame components. The left illustration is a side view of a lower end rack frame component (3E2) secured to a structure (2), with an optionally installed full width spacer (4OS), mounting studs (4W), with a section view of a rod (6) installed within the rack frame (4). The center illustration is a side view of a lower end rack frame component (3E2) secured to a structure (2), with mounting studs (4W), and a section view of a rod (6) installed within the rack frame (4). The right illustration is a side view of a lower end rack frame component (3E2) secured to a structure (2), with a channel type backing plate with an optionally installed partial width spacer (4OS), mounting studs (4W), and a section view of a rod (6) installed within the rack frame (4).

FIG. 12 is a rack bar spacing diagram showing position of rack bars (6), rack bar hole locations (6H) and incremented spacing indicator (6HS).

FIG. 13 is an elevation view of a circumferencial rack frame (3CF), with optionally installed hardware channels (4HC) optional stationary/removable rods (6OF) and removable rods (6). In this illustration the rack frame assembly is installed on a round pipe showing rack bars installed.

FIG. 14 upper illustration is a section view of a circumferencial rack frame (3CF), mounted to the wall of a round structure such as a pipe (2) secured to the pipe by either penetrating or non-penetrating connecting hardware (4P) using either a drill through or threaded hardware channel (4HP) or (4HT) for recessed or surface friction anchoring. Also shown is a section of a seated rod (6) and optionally installed rod retaining clip and/or pin (4C). The lower illustration is an opposing section view of a circumferencial rack frame (3CF), mounted to the wall of a round structure such as a pipe (2) secured to the pipe by either penetrating or non-penetrating connecting hardware (4P) using either a drill through or threaded hardware channel (4HP) or (4HT) for recessed or surface friction anchoring. Also shown is an opposing section of a seated rod (6).

FIG. 15 is combination elevation view at top and plan view at bottom of a circumferencial rack frame (3CF), and drill through or threaded hardware channel (4HP) or (4HT) for recessed or surface friction anchoring. Also shown are fully seated rods (6), partially seated rods (6P), and optionally installed stationary rods (6OF). The bottom illustration is a plan view of the rack frame (3CF) installed onto the end of an elongated structure such as a pipe showing either drill through or threaded hardware channel (4HP-4HT) for recessed or surface friction anchoring and drilled rod holes (3CHF).

FIG. 16 is an elevation view of optional grouping pattern of individual modular racks which can be grouped in any pattern, and oriented in any direction either individually or as an integrated assembly. In this example the submerged individual vertically oriented rack frames and components (3E1), (3E2), and (6), racks are installed as a group vertically (A, B, C, D) to a hydraulic structure composed of a control tower (2), operator floor (OF), flow control gate (1), gate stem (S) over facility intake openings (OP).

### DETAILED DESCRIPTION OF THE INVENTION

In the absence of prior art and in order to eliminate prior restrictions and limitations, the present invention has been devised for partial and complete modular assembly, operation, installation, removal, servicing, replacement, and reinstallation. The present invention relates to a modular debris rack installed in the marine, underwater, and other environments for preventing foreign or other materials from entering into fluid, water intake, inlet, or outlet equipment and facilities, flow control systems, hydraulic structures, waterways and marine structures and facilities either not submerged, partially submerged, and/or completely submerged. Existing equipment is prevented from rapid removal and reinstallation in whole and in part due to being constructed as a unit, and being fixed as a unit to equipment, structures, and other facilities installed by welding, embedment, riveting, bolting, and other respective permanent and semi-permanent joining and connection methods thereby preventing the removal and reinstallation of the unit, its parts, or individual elements of the constructed unit and substantially preventing and limiting efficient removal and replacement of the unit in whole and/or in part. For these reasons, there is a need in the art for a new system to permit a modularly constructed debris rack device for modular, rapid disassembly, removal, and reinstallation of its components which overcomes the above disadvantages described.

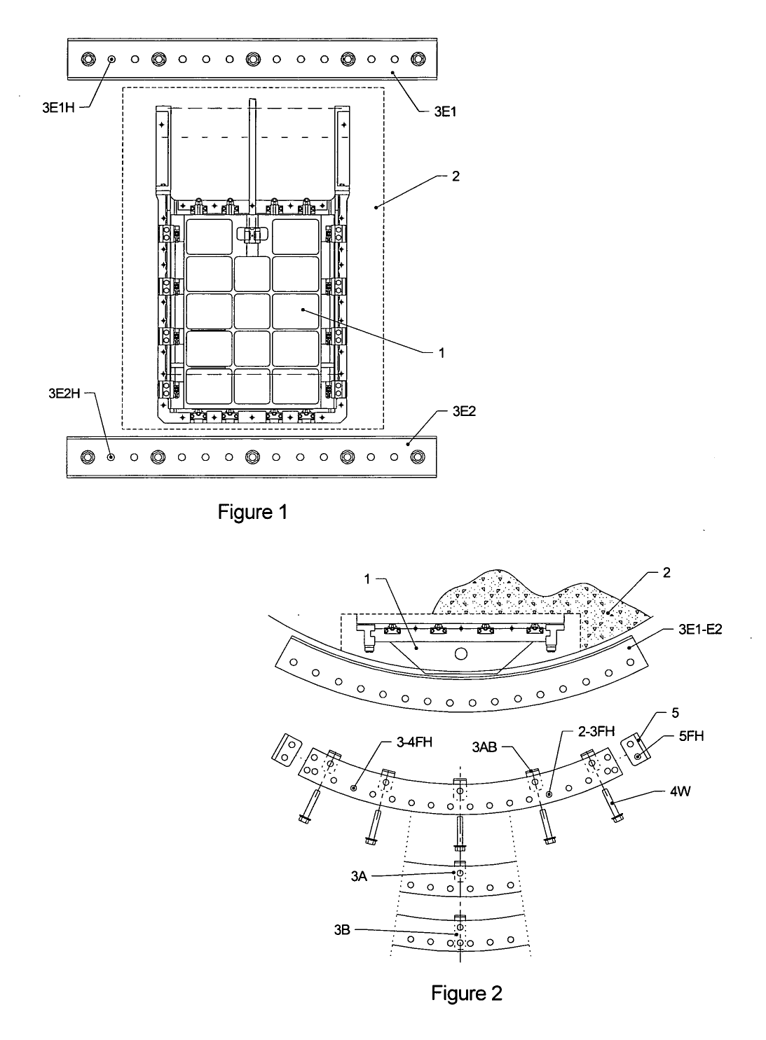

Referring now to FIG. 1, is an elevation view showing the position in this sample installation of the two rack frame component ends (3E1) and (3E2) in this case with upper and lower orientation in front of a sluice type flow control gate (1), installed in this example to a concrete control tower (2) by a selected quantity of mounting studs (3E1H) and (3E2H) in selected drilled holes in frame components. Two or more rack frame components may be used and oriented at any angle, and may be multi-sided to be installed on a variety of structure shapes and sizes. Mounting stud holes can be any size or spaced as desired. The pre-drilled spaced mounting holes allow for continued installation in the event that a mounting stud is prevented from being installed due to obstruction, localized structure defect, or other cause. In this event the installer simply moves to the next pre-drilled rack frame hole (3E1H) (3E2H) and continues with the installation of the mounting studs. This feature alone can save significant installation time through inherent installation fault tolerance.

Referring now to FIG. 2 is a plan view showing a sample installation of the modular rack frame (3E1-E2) to a curved structure (2) using mounting studs (4W) with a sluice gate type flow control device installed (1) to the structure. Other installations of this type example can be made on an irregular shaped, elliptical, curved, flat, offset, round, or other shape structures. Also shown is one of the variants to welded frame component construction using two end plates and bolted variable size brackets (3A), (3B), (3AB) with removable drilled frame end plates (5), (5FH). Also shown are drilled frame rod holes (3-4FH) for installation in this example of round frame rods. A plurality of other shaped rods or elongated structures functioning in similar capacity are also used to accommodate the removable bars which can be oriented in any linear or nonlinear position. Optionally installed hardware connected end plates (5FH) can be installed as a way to maintain equal or other spacing and orientation of two or more rack frames (3E1H-3E2H) during and after installation, increase structural rigidity, act as a solid side barrier so foreign objects do not penetrate the rack from the sides, and for estetictley pleasing and professional look. With numerous pre-drilled rack frame mounting holes (3-4FH) any number of anchor studs (4W) can be used within the limit of the quantity of number of pre-drilled holed to secure the rack frames to a structure. Partial width and full frame width rack frame brackets (3A-3B) can be used with hardware connected multi-element frames. Any number of rack frame brackets can be used within the limit of the quantity of number of pre-drilled holes in the rack frame backing plate to secure the rack frames to a structure. Rack frames can be one piece extruded, welded combined multi-element, fitted and hardware connected multi-element.

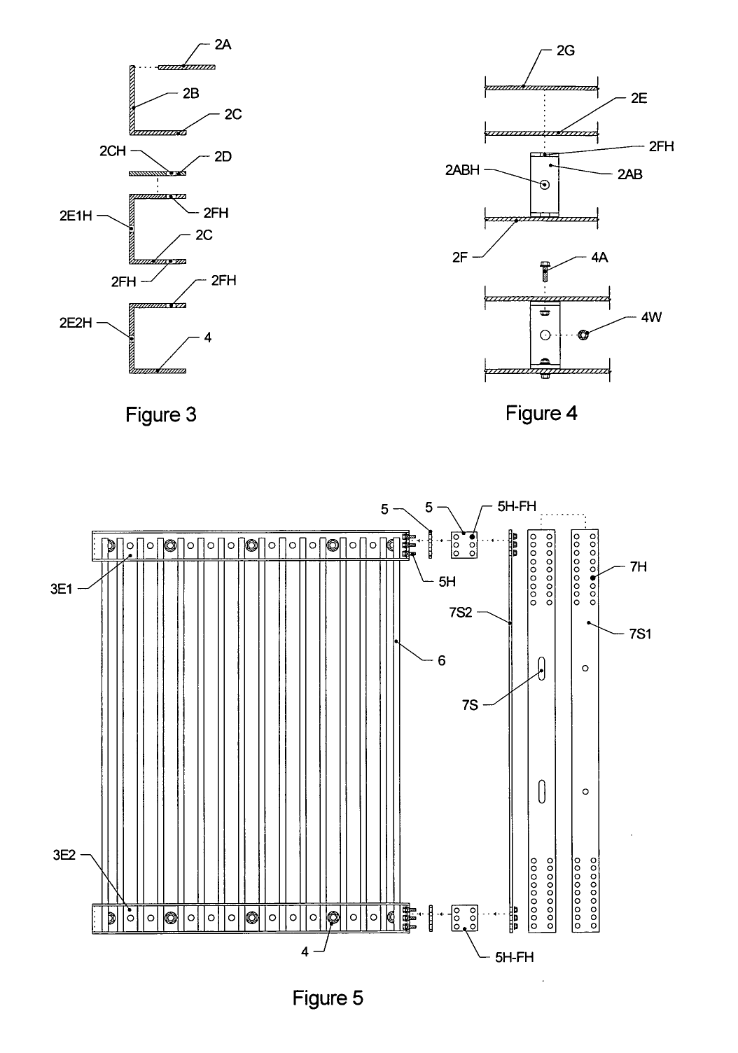

Referring now to FIG. 3, upper illustration is a longitudinal side section view of a welded combined multi-element rack frame shown in vertical orientation. In this optional frame configuration, a plurality of plates or frame components are joined by welding, fusing, adhesion, or other semi-permanent or permanent connection method in a configuration to support, contain, and guide the rack frame bars. The three components consist of a top rod pass through plate (2A), a backing plate which is typically secured to a structure by anchor studs or other hardware or mechanical device with the rack frame(s) attached to a structure either under tension with minimal tools, or studs installed as hanger hardware with rack frame(s) being hung from the hanger studs secured by keyed slots or similar such integrated or attached feature or accessory permitting the modular debris rack(s) and all components to be installed without tools, and the bottom rod pass through plate (2C). The middle illustration is a longitudinal side section view of an assembled combined multi-element rack frame shown in vertical orientation with a drilled upper rod pass through plate (2FH), a drilled backing plate typically used to secure the frame to a structure by anchor studs or other hardware or mechanical device (2E1H), a drilled bottom rod pass through plate (2FH) and an optional rod retention end plate (2D) which is secured to the top plate (2A) by a variety of means to cover the rod insertion holes once the rods have been inserted. The lower illustration is a longitudinal side section view of an assembled combined multi-element rack frame shown in vertical orientation with a drilled upper rod pass through plate (2FH), a drilled backing plate typically used to secure the frame to a structure by anchor studs or other hardware or mechanical device (2E2H), and a solid bottom rod retention/stop plate (4). In this configuration the rack rods pass through the upper frame top and bottom plates, pass through the upper plate of the bottom frame and seats against the inside surface of the bottom frame plate. Optionally, end plates may be installed at both upper and lower or opposing positions to retain the rack frame bars within the rack frame assembly. Typical rack frame bar guide hole patterns are shown with one rack frame having rod holes in two plates and one rack frame with rod holes in one plate. A plurality of rack frames with guide holes through two plates may be used.

Referring now to FIG. 4, is an elevation section front view of a hardware assembled rack frame showing the primary parts of a rack frame which in this variant of the various construction and configuration types without limitation. The top illustration shows the individual hardware assembled components including the top plate (2E), top and bottom or opposing plate mounting brackets (2AB), and bottom plate (2F). Also shown is an optionally installed hardware connected plate cap used for rod retention (2G). The bottom illustration shows the three elements combined as a vertically oriented upper end rack frame component with the mounting bracket positioned as installed with connecting plate hardware (4A), and frame mounting hardware (4W). Any number of rack frame mounting brackets (2AB) can be used by themselves without opposing rack frame plates (2E) and (2F) or other hardware connected rod restraint elements either individually or a plurality of brackets as a rack frame element to contain rack frame bars, to connect a plurality of frame plates or elements of different shape together, and rack frames to a structure. Rack frames can be any size, shape, and configuration which permits the installation and rapid removal of rack frame rods without tools or equipment.

Referring now to FIG. 5, is a combination side and elevation front view of curved upper and lower rack frame components (3E1), and (3E2) with rack frame bars (6), rack frame mounting studs (4), and optionally installed hardware connected end plate mounting flanges (5) drilled for connecting hardware (5H-FH). Also shown are optionally installed side plates shown face view (7S1), and side view (7S2). Side plates may be pre-drilled (7H) or slotted (7S) in a pattern for infield adjustment for desired rack frame separation. Modular racks may be constructed of two or more rack frame elements positioned between or added to opposing plates, parallel, at angles to each other, or caged, as a multi-sided structure with the rack frame component(s) interconnecting hardware and a plurality of structure mounting holes. The distance between opposing or upper and lower rack frames can be individually or jointly changed by securing the rack frames to different holes on the side caps which can be optionally stacked for added rigidity. Rack frame retention elements in general and In this example, rack frame rods (6) which are not load bearing structural components of the rack frame can be made from any elongated structure being either rigid or non-rigid materials of any shape and size are inserted into the predrilled holes in the rack frame elements functioning as the rack frame retention element preventing foreign or other materials from passing through the rack frame assembly. The rack frame retention elements can be quickly removed without tools.

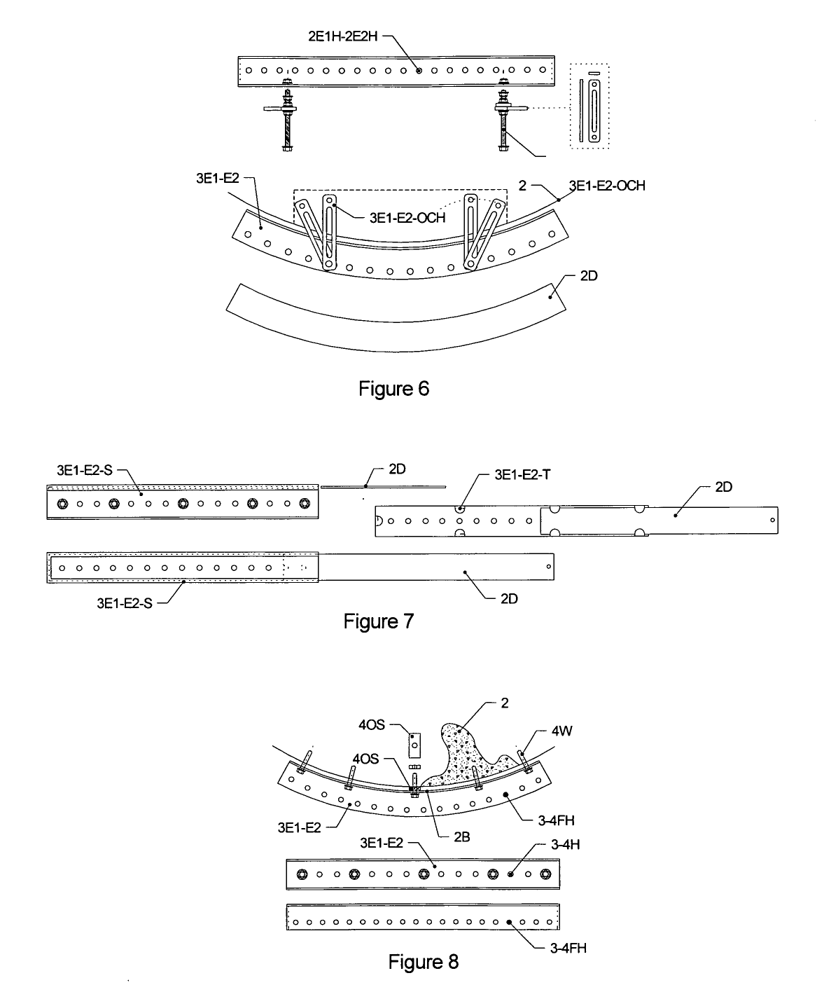

Referring now to FIG. 6, is a combination elevation front view of an assembled rack frame component (3E1-E2), with drilled back plate mounting holes (2E1H/2E2H) and plan view of a rack frame component (3E1-E2) with temporary and optionally installed centering arms and connecting hardware accessories (3E1-E2-OCH). Also shown is an optionally installed plate cap (2D) for rod retention. The optionally installed centering arms which are an optional accessory to the rack frame assembly and not part of the modular rack itself, can be used as a removable mechanism for centering the rack frame assembly over the installation area during the installation to a structure. Once the mounting hardware has been installed, the centering arms are removed. This is only one example of how the predrilled rack frame components can accept a wide range of handling and installation aids and accessories.

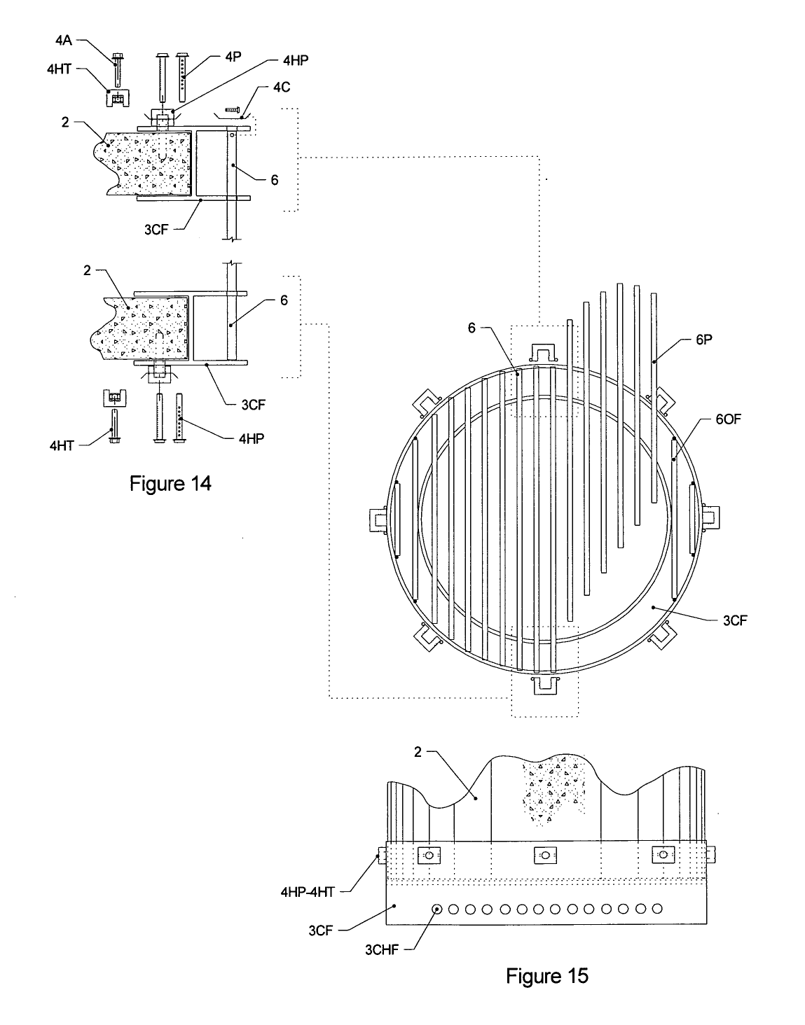

Referring now to FIG. 7, is a combination elevation front view of a straight rack frame component (3E1-E2-S) with orientation of optionally installed rack frame sliding plate cap (2D) and a plan view of an optionally installed rack frame (3E1-E2-T) with tabbed sliding plate cap (2D) secured by a continuous length channel and partial length tabs. The optional rack frame caps shown are hardware connected as shown in FIG. 3 and FIG. 4, and free of connecting hardware as shown in FIG. 7 by sliding the single or plurality of cap plates over, under, adjacent to, or within the rack frame to restrain the rack rods and/or retention element(s) from movement. Other methods of rod retention can also be used such as pull type pins or clips installed to each individual rod or retention element as shown later herein in FIG. 14.

Referring now to FIG. 8, is a combination an elevation front and plan views of a straight rack frame component (3E1-E2) at bottom with pre-drilled mounting stud holes (3-4H), and rack frame rod holes (3-4FH), and a plan view at top of a curved rack frame component (3E1-E2), with pre-drilled rack frame rod holes (3-4H), and rack frame mounting studs (4W), with optionally installed rack frame spacer (4OS) typically installed behind the rack frame back plate (2B). The bottom illustration is a plan view of the curved rack frame where the predrilled rod insertion holes (3-4FH) in the rack frames (3E1-E2) provide multiple lifting and handling points. Spacers (4OS) composed of solid or compressible materials may be installed between the rack frame(s) and the structure (2) to compensate for minor structure surface irregularities, expansion, contraction, and other conditions.

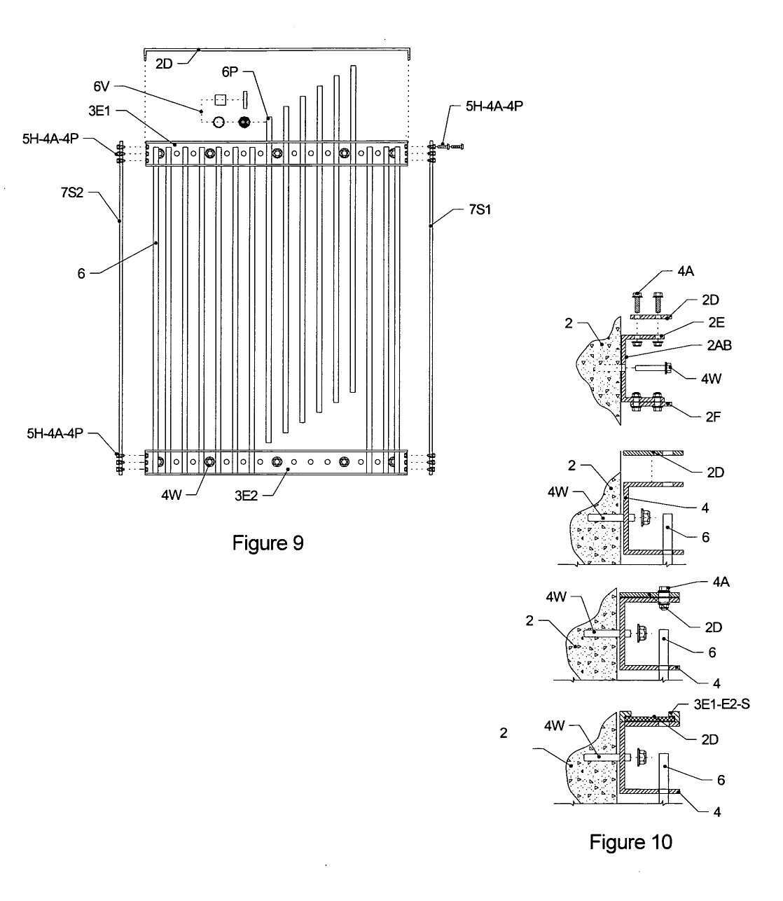

Referring now to FIG. 9, is an elevation view of a rack assembly variant oriented vertically with upper and lower rack frames (3E1) and (3E2), rack bars positions as being installed from the top (6P), and installation with rods fully seated (6). Also shown are various rigid rod shapes (6V) which can be used for the rack retention elements, however rack retention elements can be either rigid or flexible without limitation to material composition, shape, dimension, or size which may be used between and within the rack frames. Also shown is an optionally installed hardware secured end plate cap (2D), and rack frame side plates (7S1) and (7S2) with connecting hardware at each end (5H-4A-4P) which are typically installed to add structural rigidity in certain rack configurations, and to fit flush against a structure to prevent foreign materials from passing through the modular rack assembly from the sides. The end cap(s) (7S1-7S2) may be connected in a variety of ways such as hardware connected (5H-4A-4P), or without hardware or tools by using grooves, slots, channels, etc. Referring now to FIG. 10, is a group of four side section views. The top illustration is a hardware assembled upper rack frame plate mounting bracket (2AB) secured to a structure (2), with mounting studs (4W), with a rack bar plate cap (2D) positioned to be secured to the top plate (2E) by connecting hardware (4A). Also shown is the bottom plate (2F) attached to the frame mounting bracket (2AB). This rack frame variant utilizes brackets or bracket like hardware (2AB) to mount to a structure (2) and to connect the opposing rod retention plates, (2E-2F) flanges, and other similar functioning shaped elements. Also incorporated within each bracket are structure mounting hole(s) to affix the individual bracket(s) to a structure using mounting hardware such as studs or other such connective hardware. The second illustration down from the top is a side view showing a weld assembled upper end rack frame component (4) secured to a structure (2), with mounting studs (4W), with a rack bar plate cap (2D) positioned to be secured to the top plate. Also shown is a section view of a rod (6) installed within the rack frame (4). The optionally installed plate cap (2D) may be used to restrain and lock the rods within the rack frame so rods cannot be pulled out. The plate caps may be rigid solid plate, mesh, grill, screen, or flexible materials with offset holes, slots, or other configurations where connective hardware for removal of rods or plate caps is not required. The third illustration down from the top is a side view showing a weld assembled upper end rack frame component (4) secured to a structure (2), with mounting studs (4W), with a rack bar plate cap (2D) installed on the top plate with connecting hardware (4A). Rack frame components can be either a single element, or a plurality of individual elements joined together by being extruded, molded, cast, welded, bonded, fused, glued, or joined together by other means to comprise a rack frame component. The bottom illustration is a side view showing a weld assembled slotted/tab upper end rack frame component (3E1-E2-S)/(3E1-E2-T) secured to a structure (2), with mounting studs (4W), with a rack bar plate cap (2D) positioned to be secured to the top plate. Also shown is a section view of a rod (6) installed within the rack frame (4). Also shown is an optionally installed rack frame sliding plate cap (2D) contained within a channeled, tabbed, or other rack frame element shape to receive and contain the end cap plate without tools.

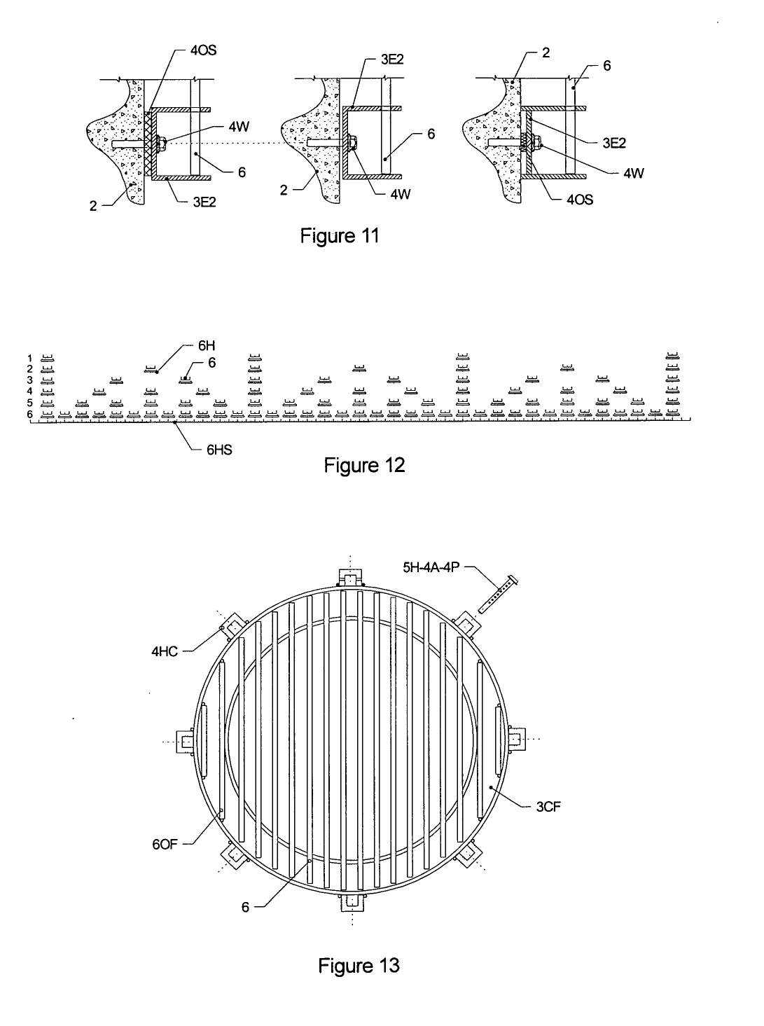

Referring now to FIG. 11, is a group of three side section views of four lower rack frame components. The left illustration is a side view of a lower end rack frame component (3E2) secured to a structure (2), with an optionally installed full width spacer (4OS), mounting studs (4W), with a section view of a rod (6) installed within the rack frame (4). Spacers (4OS) composed of solid or compressible materials may be installed between the rack frame(s) and the structure (2) to permit movement, and/or compensate for minor structure surface irregularities, expansion, contraction, and other conditions. The center illustration is a side view of a lower end rack frame component (3E2) secured to a structure (2), with mounting studs (4W), and a section view of a rod (6) installed within the rack frame (4). The right illustration is a side view of a lower end rack frame component (3E2) secured to a structure (2), showing a section of a rack frame rod (6), with a channel type backing plate with an optionally installed partial width spacer (4OS), mounting studs (4W), a Spacers (4OS) composed of solid or compressible materials may be installed between the rack frame(s) and the structure (2) to permit movement, and/or compensate for minor structure surface irregularities, expansion, contraction, and other conditions. The channel type backing plate allows for rapid infield adjustment between the rack frame (3E2) and the structure (2) by removing the desired amount of channel material in the areas desired for closer contact to the structure (2). In this configuration the optionally installed spacers (4OS) can be used for backing plate anti-deflection or structural support.

Referring now to FIG. 12, is a rack bar spacing diagram showing position of rack bars (6), rack bar hole locations (6H) and incremented spacing indicator (6HS). The illustration represents a sectional elevation matrix view of optional rack frame bar installation spacing options in which the number of rack frame bar holes within a rack frame component permits equal and/or unequal rack bar spacing options. Rack bar holes can be any quantity and partially or completely populated with rods or other rack restraint elements and spaced as desired. Any number of rack frame holes may be used and the total of thirty seven (37) holes are used in this matrix. Shown are examples of equal distance rod spacing and rod hole population based on a rack frame with thirty seven (37) rod holes. Line one shows an option of four (4) equally spaced rods. Line two (2) shows an option of seven (7) equally spaced rods. Line three (3) shows an option of ten (10) equally spaced rods. Line four (4) shows an option of thirteen (13) equally spaced rods. Line five (5) shows an option of nineteen (19) equally spaced rods. Line six (6) shows an option of ten (37) equally spaced rods. Asymmetrical or unequal rod or rack retention element spacing without limitation to configuration is also an option as detailed above.

Referring now to FIG. 13, is an elevation view of an optional shaped circumferencial rack frame (3CF), with optionally installed hardware channels (4HC) optional stationary rods (6OF) and removable rods (6). In this illustration the rack frame assembly is installed on a round pipe end showing parallel rack bars installed. Round rack frames can be clear span as shown or with a center hub or other structure to contain the rack bars or rack retention elements within the rack frame. Bars can also be installed in a cross, perpendicular, conical, radial, or other pattern as may be desired or required, and may be installed and extracted from one side of the rack frame or multiple sides. It can also be installed inline and within the pipe length at either pipe joints, connections, and at other points along the length of a pipe, conduit, channel, or other similar elongated or other shaped structure without limitation. Also shown are optionally attached rack frame mounting hardware channels which can be installed at a single or plurality of symmetrical or asymmetrical anchor points around the rack frame.

Referring now to FIG. 14, upper illustration is a section view of a circumferencial rack frame (3CF), mounted to the wall end of a round structure such as a pipe (2) secured to the pipe by either penetrating or non-penetrating connecting hardware (4P) using either a drill through with threaded hardware such as bolts, non-threaded hardware such as pins and clips, threaded channel(s) (4HP) or non-threaded channels with threaded inserts such as nuts (4HT) for recessed or surface friction anchoring. Also shown is a section of a seated rod (6) as positioned through the upper section of the rack frame and optionally installed rod retaining clip and/or pin (4C) which can be installed as a rod retention component in place of an end cap(s). Also shown is a section of a rod (6) inserted through the upper and lower plates of an upper rack frame (3CF). The lower illustration is an opposing section view of a circumferencial rack frame (3CF), mounted to the wall of a round structure such as a pipe with the same connective components and options as the upper illustration. Also shown is an opposing section of a seated rod (6) through the upper plate of a lower or opposing rack frame (3CF) seating against the inside surface of the lower rack frame plate (3CF) with optionally installed rod retaining clip and/or pin (4C) which can be installed as a rod retention component in place of an end cap(s).

Referring now to FIG. 15, is combination elevation view at top and plan view at bottom of a circumferencial rack frame (3CF), and drill through or threaded hardware channel (4HP) or (4HT) for recessed or surface friction anchoring with the same features and elements as with FIGS. 13 and 14. Also shown are both fully seated rods (6), partially seated rods (6P) and optionally installed stationary rods (6OF). Rack frames and bars can be installed without limitation to size and diameter of pipe or other round structures and structure openings. The bottom illustration is a plan view of the rack frame (3CF) installed onto the end of an elongated structure such as a pipe showing hardware channel(s) (4HP-4HT) for recessed or surface friction anchoring and drilled rod holes (3CHF) using either a drill through with threaded hardware such as bolts, non-threaded hardware such as pins and clips, threaded channel(s) (4HP) or non-threaded channels with threaded inserts such as nuts (4HT) for recessed or surface friction anchoring.

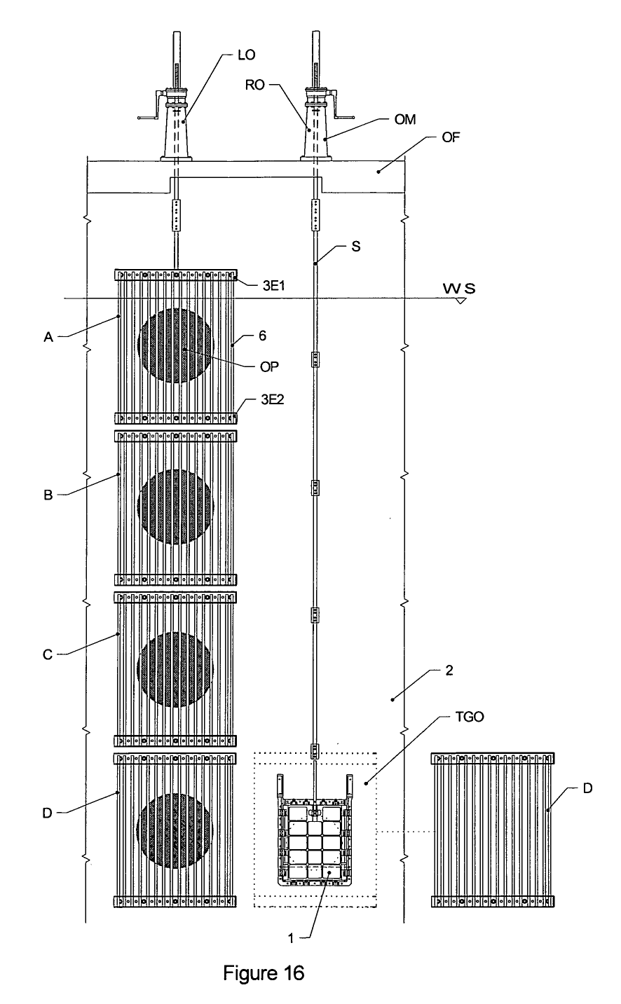

Referring now to FIG. 16, is an elevation view of optional grouping pattern of individual modular racks which can be grouped in any pattern, or shape, and oriented in any direction either individually, in clusters, or as an integrated assembly. In this example and left operator side (LO), the submerged individual vertically oriented rack frames and components (3E1), (3E2), and (6), racks are installed as a group vertically (A, B, C, D) to a hydraulic structure with multiple intakes (OP) behind the modular racks of a dam control tower. The right operator side (RO) shows a single flow control sluice gate (1) with a single modular rack (D) to the right to be installed in front of the tower gate opening (TGO). Also shown in this installation example is a control tower (2), operator floor (OF), flow control gate (1), gate stem (S) over facility intake openings (OP). A hydraulic structure as shown in FIG. 16 is one of may types of structures that the modular racks can be installed in numerous ways with numerous structures limited only by the imagination of the installer.

The above described invention provides modular debris rack installation in the marine and/or underwater and other environments for preventing foreign or other materials from entering into fluid, water intake, inlet, or outlet equipment and facilities, flow control systems, hydraulic structures, waterways and marine structures and facilities either not submerged, partially submerged, and/or completely submerged. It is a means for preventing foreign or other materials from entering into fluid, water intake, inlet, or outlet equipment and facilities, flow control systems, hydraulic structures, waterways and marine structures and facilities and/or retaining foreign or other materials at or within such structures and waterways being comprised of one or plurality of linear or curved upper, lower and/or side to side rack frames, and/or optionally installed intermediate rack frames with solid or tubular round, square, rectangle, angled, or other shape removable rigid rack bars, and/or removable flexible rack cables, cords, chain, rope, or other type flexible longitudinal structures to fit the desired rack orientation and spacing installation requirements. The modular debris rack permits rapid removal and reinstallation of rack bar components without tools and simple removal or replacement of individual rack frame components with minimal tools, and permits rapid access to flow control devices and other equipment and facilities located behind the modular debris rack for inspection, maintenance, repair and replacement. The modular debris rack frame can be any size and shape, and be single or multi-sided, made from any semi-rigid and/or rigid materials such as steel, aluminum, fiberglass, plastics, and other elements to any required size or shape installed either individually, grouping, stacking, or layering and can be installed at any angle or orientation. The above described invention provides the following advantages:

The above invention advantages and uses may be employed in any area of application limited only by the imagination of the user-inclusive and not limited to the marine environment, and applications such as:

1. Underwater, above water, in air, at water transition areas and fluids.

### 2. Semi-submerged.

### 3. Utilities

4. Spillways, drainage systems, and culverts.
5. Intake structures.
6. Hydraulic structures.
7. Marine facilities, structures, and equipment.
8. Sluice gates.

### 9. Valves.

10. Submerged, and semi-submerged intakes.

### 11. Dams.

### 12. Pumps.

13. Water distribution systems.
14. Raw water intakes.
15. Tide gate systems.

### 16. Reservoirs.

### 17. Rivers.

### 18. Lakes.

### 19. Outfalls

20. Numerous installations limited only by the imagination of the installer.

1. A modular debris rack permitting rapid removal and reinstallation of its components without tools, being modular in design, construction, capability, installation, maintenance, replacement, repair, modification, assembly and disassembly; and wherein
can be installed above water, underwater, partially submerged, in air, or fluid; and wherein is installed, removed, and reinstalled with the original components without destruction or modification to any of it's components; and wherein it's rack frame rods and rack retention elements are not limited to parallel orientation; and wherein is not rigidly connected to each other by linking or connecting hardware; and wherein does not contain connecting or other type hardware that is material dependent; and wherein are not coupled together with connecting or other type hardware or contain an internal core or other assembly; and wherein does not use spacers between its longitudinal elements and is not bound together as a unit or to form a grid and is not dependent on any one type of material in it's function, design, performance, or construction.

2. A modular debris rack that can be installed on flat, curved, round, offset, domed, and irregular shaped surfaces above or below the water or fluid surface, in single and/or multiple planes and can be stacked or layered as a single independent unit or grouped or clustered in individual or related multiple assemblies; and wherein may be used and oriented at any angle; and wherein may be multi-sided to be installed on a variety of structure shapes, sizes and configuration in a cross, mesh, perpendicular, conical, radial, or other pattern as may be desired or required; and wherein be installed and extracted from a single or plurality of sides of the rack which permits the installation and rapid removal of the rack elements without tools or equipment; and wherein the number and spacing of the rack bars and rack retention elements being equal and/or unequal can be changed by hand quickly, easily, and without tools before, during, or after installation to achieve retention of differing debris types and sizes being fully adjustable after installation without tools.

3. A modular debris rack that can be any size and shape, be single or multi-sided, made from any semi-rigid and/or rigid materials such as steel, aluminum, fiberglass, plastics, and other element materials and composition to maintain it's desired structural integrity being rigid or flexible to any required size or shape; and wherein it can be assembled with hardware, fused, welded, glued, press fit, keyed together and joined by a variety of methods either with or without tools; and wherein can be installed at any angle or orientation; and wherein it's dimensions can be adjusted in length, width, or depth before, during, and/or after installation with or without tools; and wherein preventing foreign and other materials from entering into fluid, water intake, inlet, or outlet equipment and other facilities by preventing debris and other unwanted materials from passing through the rack frame assembly.

4. The modular debris rack of claim 2, wherein it's modular design and predrilled rod holes and slots provides integrated rigging, and multiple lifting and handling points wherein can be installed over, adjacent to, or within any shape opening while having a professional and aesthetically pleasing appearance with functional performance.

5. The modular debris rack of claim 1, wherein it permits rapid removal and reinstallation of rack bar components without tools and simple removal or replacement of individual rack frame components with minimal tools, and permits rapid access to flow control devices and other equipment and facilities located behind, adjacent to, inline, and in connection with the modular debris rack for inspection, maintenance, repair and replacement.

6. The modular debris rack of claim 3, wherein it's rack bars and rack retention elements can be made of solid or tubular round, square, rectangle, angled, or other shape removable rigid rack bars, and/or removable flexible rack cables, cords, chain, rope, or other type flexible longitudinal structures to fit the desired rack orientation and spacing installation requirements, wherein it's rack frames can be one piece extruded, welded combined multi-element, fitted
and hardware connected multi-element wherein it's components can be individually or jointly repositioned by securing the rack frames to different holes on the side caps.

7. The modular debris rack of claim 3, wherein it has inherent installation fault tolerance and allows for continued and uninterrupted installation due to obstruction, localized structure defect or other cause or condition, wherein it's optionally installed end plates may be installed at upper, lower, opposing, asymmetrical and other positions to retain the rack frame bars within the rack frame assembly and may be constructed of two or more rack frame elements positioned between or added to opposing plates, parallel, at angles to each other, or caged, as a multi-sided structure, wherein it can accept a wide range of handling and installation aids and accessories.

8. The modular debris rack of claim 3, wherein it can inherently compensate for minor structure surface irregularities, expansion, contraction, and other conditions and allows for rapid infield adjustment between the rack frame(s) and the structure, wherein it's rods and/or rack retention elements can be either rigid or flexible without limitation to material composition, shape, dimension, or size, wherein it's end plates, caps and such elements may be rigid solid plate, mesh, grill, screen, or flexible materials with offset holes, slots, or other configurations.

9. The modular debris rack of claim 2, wherein it's rack frame components can be either a single element, or a plurality of individual elements joined together by being extruded, molded, cast, welded, bonded, fused, glued, or joined together by other means to comprise a rack frame component, wherein it's removable rack bar and retention element spacing can be equal and/or unequal and be changed before, during, and after installation anytime without tools, wherein it permits asymmetrical or unequal rod or rack retention element spacing without limitation to configuration, wherein it's rack bar and retention element holes can be any quantity and position and be partially or completely populated with rods, or other rack restraint elements and spaced as desired.

10. The modular debris rack of claim 1, wherein it permits rapid access to flow control devices and other equipment and facilities for inspection, maintenance, repair and replacement, wherein it can be installed inline and within the pipe length at either pipe joints, connections and other points along the length of a pipe, conduit, channel, or other similar elongated or other shaped structure without limitation, wherein can be any size, shape, be single or multi-sided, wherein it can be made from any semi-rigid and/or rigid materials such as steel, aluminum, fiberglass, plastics, and other materials to any required size or shape.

11. The modular debris rack of claim 1, wherein it's removable rack frame rods and rack retention elements can be solid or tubular, round, square, rectangle, angled, or other shape and be composed of cables, cords, chain, line, rope, or other type flexible longitudinal structures to fit the desired rack, wherein it can be installed in numerous ways with numerous structures limited only by the imagination of the installer.

12. The modular debris rack of claim 1, wherein it's rack frames can be made as a single element, combined single element components or multi-element components, wherein it can be secured to a structure by anchor studs or other hardware or mechanical device either under tension with minimal tools, or hung from the hanger studs secured by keyed slots or similar such integrated or attached feature or accessory permitting the modular debris rack(s) and all components to be installed without tools, wherein the rack bars and rack retention elements when submerged in a fluid environment can vary their weight in fluid by regulating the amount of air or gas within the rack bars.

13. The modular debris rack of claim 2, wherein it can be manufactured to be mounted and/or installed to or within virtually any structure, wherein the rack bars and rack retention elements can also be installed and extracted from one side, end, or section of the rack frame or multiple such locations, wherein it's rack frame bars and rack retention elements can be contained within the rack frame if desired by using gravity, retaining plates, pins, clips, cables, and other removable or permanent securing hardware, wherein it inherently provides multiple lifting and handling points, wherein it is modular therefore it is easy to transport and can be easily rigged with flotation modules to assist in floating marine transportation, handling and installation in marine and underwater environments.

14. The modular debris rack of claim 3, wherein it's rack frame can be composed of many types and shape materials such as solid beams, channels, blocks, solid or hollow bars, rods, tubes, and other such rigid elongated structures, wherein it permits in-place corrective, or modified mounting with surface contour adjustments to irregular surfaces.

15. The modular debris rack of claim 2, wherein it's rack frame bars and rack retention elements can be composed of various elongated structure types such as solid beams, channels, angles, blocks, solid or hollow bars, rods, tubes, and other such rigid elongated structures and solid, hollow, or flexible combined strand or single element type elongated materials and structures such as cables, ropes, lines, and other such flexible static, slack, tensioned, or pre-sprung materials and structures.
